(19) United States
(12) Patent Application Publication
(10) Pub. No.: US 2012/0143681 A1
(43) Pub. Date: Jun. 7, 2012

(54) ROOM-BASED COMPUTING ENVIRONMENTS

(75) Inventors: Mark Alcazar, Seattle, WA (US); Oscar E. Murillo, Redmond, WA (US); Daniel Edward Walther, II, Redmond, WA (US)

(73) Assignee: Microsoft Corporation, Redmond, WA (US)

(21) Appl. No.: 12/958,415

(22) Filed: Dec. 2, 2010

(51) Int. Cl. G06Q 30/00; G06F 21/00; G06F 17/30

(52) U.S. Cl. 705/14.49; 707/740; 726/4; 705/14.4; 705/14.73; 707/E17.089

(57) ABSTRACT

Concepts and technologies for creating and accessing room-based computing environments are disclosed. Resources are categorized and/or bundled into categories or bundles of resources. Resources are associated with the room-based computing environment and various data relating to the resources is stored, including data relating to permissions for accessing the resources. Upon detecting access of the room-based computing environment, a room engine can authenticate an entity associated with the access and determine what contents of the room-based computing environment are to be presented based upon the permissions information and/or other considerations. The environment is generated and presented to the entity via one or more user interfaces.

### BACKGROUND

Entities sometimes perform various activities using computing devices such as performing web searching, accessing web-based or other types of applications, accessing files or other resources, accessing or updating social networking information, and the like. In some instances, these activities are related to one another and/or to a particular topic, and/or may be repeated often. Furthermore, users may wish to share information or resources identified during these activities. While these activities may be related and may be repeated often, there may be no easy way to repeat these activities, let alone to share the information or resources identified during these activities with others.

Furthermore, while users may wish to share the identified information or resources with other entities, these users simultaneously may wish to restrict access to the shared information or resources by unauthorized entities. In some instances, users may wish to share some information with particular entities, but may wish to restrict access to other information to the same entities. Also, users may wish to share some information with all entities, but restrict some information with respect to all or select entities. Because users may not be able restrict access to some or all of the information in accordance with these and other concerns, the ability to share information or resources may be limited for additional reasons.

Additionally, information and/or resources identified during these and other activities may be cumbersome to navigate and/or may require complicated user interfaces, commands, and/or hard coding to achieve the desired functionality. While some services or web sites allow users to share particular information with other entities and to set permissions associated with shared information, these interfaces are not conducive to sharing large and/or varied types of data or resources with other users and/or controlling access to the shared data or resources, and may be difficult to navigate, particularly when users restrict access to some of the information.

It is with respect to these and other considerations that the disclosure made herein is presented.

### SUMMARY

Concepts and technologies are described herein for room-based computing environments. In accordance with the concepts and technologies disclosed herein, applications, web sites, services, web pages, and/or other content (“resources”) are categorized and/or bundled into categories or bundles of resources. These categories or bundles of resources are referred to as “rooms,” which can be represented as information relating to logical groupings of resources and/or by graphical representations of information and/or links to information forms representative of physical rooms. The word “room” therefore is used herein to refer to collections and other hierarchical collections and/or bundles of resources that are related to, or may be considered pertinent to, a particular topic. The concepts and technologies herein also relate to graphical navigation of the room-based computing environment, wherein the rooms correspond to graphical representations for accessing the collections or bundles of resources. The concepts and technologies disclosed herein also relate to additional or alternative groupings of resources including, but not limited to, buildings containing one or more rooms, one or more items within the rooms, and/or individual resources.

According to one aspect, a client in communication with a room engine generates a room based computing environment by creating a buildings, rooms, items, and the like, and populating the buildings, rooms, items and the like with particular resources. Generation of the contents of the room-based computing environment can be based, at least in part, upon search data received form search engines, social networking data received from social networking services, input received from one or more users, and other data. The input received from the users can include, but is not limited to, permissions information relating to the buildings, rooms, items, and the like. The other data can include, but is not limited to, location data, device data, and the like, which can be associated with the buildings, the rooms, the items, and/or particular resources.

According to another aspect, the room-based computing environment is accessed by and entity, and the room engine determines the contents of the room-based computing environment. In some implementations, the entity is authenticated to determine if the entity has permission to access the room-based computing environment, and if so, to additionally determine what to display as the contents of the room-based computing environment. The determined contents also can include advertising and/or other information, which can be presented to the entity in the room-based computing environment.

According to another aspect, user interfaces for navigating the room-based computing environments are disclosed. The user interfaces can be used to view the resources in various levels of detail and/or granularity, with the contents of the various views being varied based, at least partially, upon access controls and/or other considerations. Advertising and other content can be displayed with the room-based computing environment, if desired.

According to another aspect, the notion of keys are used to logically and graphically represent permissioning and access control in the room-based computing environment. Keys corresponding to tokens, passwords, access codes, and/or other information can be granted to users and used by the users to access buildings, rooms, items, and/or resources. Various keys may be required to access various aspects of the room-based computing environments, as determined by one or more users associated with the room-based computing environments.

According to various embodiments, the client is configured to execute a traditional operating system, and in other embodiments, the client is configured to execute a web-based operating system. Thus, the client may execute an operating system or other base program that is configured to access web-based or other remotely-executed applications and services to provide specific functionality at the client device. The client therefore may provide various applications and services via a simple operating system or an application comparable to a standard web browser.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an exemplary operating environment for the various embodiments disclosed herein.

FIG. 2 is a flow diagram showing aspects of a method for generating rooms for a room-based computing environment, according to an exemplary embodiment.

FIG. 3 is a flow diagram showing aspects of a method for providing access to a room-based computing environment, according to an exemplary embodiment.

FIGS. 4A-4C are user interface diagrams showing aspects of exemplary user interfaces for providing access to room-based computing environments, according to various embodiments.

FIG. 5 is a computer architecture diagram illustrating an exemplary computer hardware and software architecture for a computing system capable of implementing aspects of the embodiments presented herein.

### DETAILED DESCRIPTION

The following detailed description is directed to concepts and technologies for creating and accessing room-based computing environments. According to the concepts and technologies described herein, resources are categorized and/or bundled into categories or bundles of resources. These categories or bundles of resources can be divided into various levels of categorization. In some embodiments, these various levels are conceptually and graphically represented by one or more buildings, one or more rooms associated with the one or more buildings, one or more items associated with the one or more rooms, and/or one or more resources associated with any of the buildings, rooms, and/or items.

According to various implementations, resources are associated with the room-based computing environment and data relating to the resources is stored. The data can include information identifying how the resource can be accessed such as, for example, a network link or other information. The data also can include geographic location information associated with the resource, social networking information associated with the resource, search information associated with the resource, advertising information associated with the resource, and/or other information. Permissions can be set for accessing the resources, and the data can be stored as room data.

In response to detecting access of the room-based computing environment, a room engine can authenticate an entity associated with the access and determine what contents of the room-based computing environment are to be presented based upon the permissions information and/or other considerations. The environment is generated and presented to the entity via one or more user interfaces (“UIs”). The room-based computing environment can be navigated via the UIs from through varying levels of granularity, if desired, and the resources associated with the room-based computing environment can be accessed and/or executed.

The word “room” and variants thereof, is used herein to refer to a category or other grouping of resources. According to various embodiments, rooms are represented by logical groupings of resources and/or by graphical representations of information and/or links to information forms representative of physical rooms. As such, rooms refer herein to groupings, categories, and other collections and/or bundles of resources that are related to, or may be considered pertinent to, one or more topics or groups of topics, as well as graphical representations for accessing the collections or bundles of resources. The word “resources,” as used herein, is used to refer to data associated with or generated by applications, services, web pages, web sites, files, application data, social networking data, search data, and/or other information that may be consumed or used by a client.

The word “application,” and variants thereof, is used herein to refer to computer-executable files for providing functionality to a user. According to various embodiments, the applications can be executed by a device, for example a computer, smartphone, or the like. Additionally, the computer, smartphone, or other device can execute a web browser or operating system that is configured to access remotely-executed applications and/or services such as web-based and/or other remotely-executed applications, web pages, social networking services, and the like. In some embodiments, the applications, web pages, and/or social networking services are provided by a combination of remote and local execution, for example, by execution of JavaScript, DHTML, AJAX, .ASP, and the like. According to other embodiments, the applications include runtime applications built to access remote or local data. These runtime applications can be built using the SILVERLIGHT family of products from Microsoft Corporation in Redmond, Wash., the AIR and FLASH families of products from Adobe Systems Incorporated of San Jose, Calif., and/or other products and technologies.

For purposes of the specification and claims, the phrase “web application,” and variants thereof, is used to refer to applications that are configured to execute entirely or in-part on web servers and clients. Web applications can include multitier applications that include, but are not limited to, a data tier for storing and/or serving data used by the multitier applications, a logic tier for executing instructions to provide the functionality of the application, and a presentation tier for rendering and displaying the application output and/or interfaces for interacting with the applications. It should be understood that the names of the tiers provided herein are exemplary, and should not be construed as being limiting in any way.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawings, in which like numerals represent like elements throughout the several figures, aspects of a computing system, computer-readable storage medium, and computer-implemented methodology for room-based computing environments will be presented.

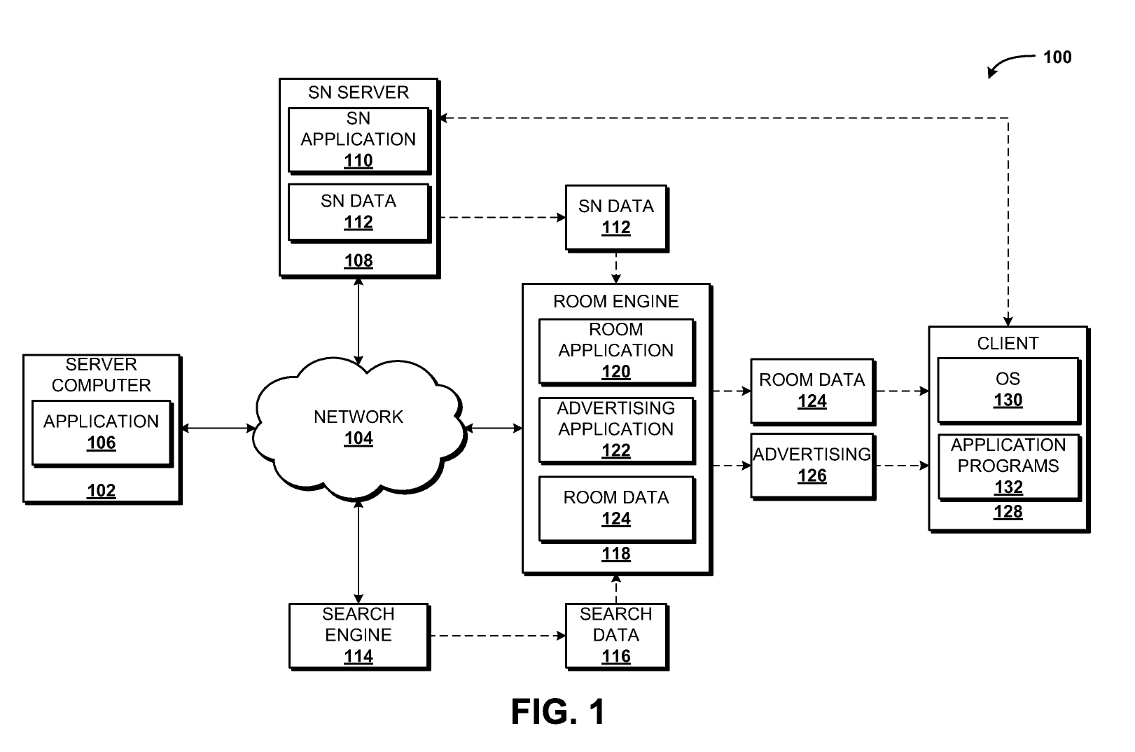

Referring now to FIG. 1, aspects of one operating environment 100 for the various embodiments presented herein will be described. The operating environment 100 shown in FIG. 1 includes a server computer 102 operating on or in communication with a network 104. According to various embodiments, the functionality of the server computer 102 is provided by a web server operating on or in communication with the Internet, though this is not necessarily the case.

The server computer 102 is configured to execute or store an application 106, web pages, and/or other content. In some embodiments, the application 106 is a server application executable by the server computer 102 to provide functionality associated with the server computer 102. In other embodiments, the server computer 102 stores the application 106 and allows other devices and/or network nodes to access, download, and/or modify the application 106. In some embodiments, the application 106 provides the server computer 102 with request-response functionality to provide, for example, web pages or other content in response to access of a public directory, to receive, respond to, and/or execute queries, and the like. It therefore should be understood that the server computer 102 can include, but is not limited to, an application server and/or a data server, and can be in communication with and/or include databases, memories, and/or other data storage devices.

In one exemplary embodiment, the server computer 102 hosts an application 106 that is executable to provide financial applications. For example, the application 106 can be used to access financial data to determine and/or provide users with account balances, to transfer funds between one or more accounts, to open and/or close accounts or lines of credit, to access account records such as account statements, to access images of cleared checks, and the like. The application 106 also can provide multimedia functionality such as, for example, video and audio playback, audio and video streaming, games, image sharing, viewing, and editing, and the like. The application 106 also can provide tools such as photo, video, and audio editing and creation applications, word processing functionality, data backup and storage functionality, calendaring applications, messaging applications such as email, text messaging, instant messaging, and realtime messaging applications, search applications, and the like. The application 106 also can provide shopping applications such as web stores and the like. The above list is not exhaustive, as the application 106 can provide any functionality. Thus, the above examples are exemplary and should not be construed as being limiting in any way.

According to various embodiments, data is generated by execution of the application 106, or the server computer 102 hosts and/or serves data corresponding to content. The content can include, but is not limited to, web pages, images, files, and the like to devices connecting to the server computer 102 via execution of the application 106. In these and other embodiments, data generated, hosted, and/or served by the server computer 102 can be made available, transmitted, and/or received by one or more devices connecting to the server computer 102. The devices can be configured to display or render the data to display the content and/or output associated with the application 106, to view files such as audio or video files, to view images, to render web pages or other content, and the like.

It should be understood that in the case of data associated with the application 106, the application 106 can be executed at the server computer 102, and output associated with the application 106 can be rendered and displayed at a device remote from the server computer 102. In other embodiments, the application 106 is executed in part by the server computer 102 and in part by devices remote from the server computer 102 such as computers, servers, and the like to provide functionality associated with the application 106. Thus, while the application 106 is illustrated as being hosted by the server computer 102, it should be understood that application components can be simultaneously executed by one or more devices, for example, to provide multitier applications.

In the illustrated embodiment, the operating environment 100 also includes a social networking server 108 (“SN server”) operating on or in communication with the network 104. The SN server 108 is configured to execute a social networking application 110 (“SN application”) to provide social networking services to one or more users. Exemplary social networking services include, but are not limited to, the TWITTER realtime messaging service, the FACEBOOK social networking service, the LINKEDIN professional networking service, the YAMMER office colleague networking service, and the like. The social networking application 110 also can include review services such as the URBANSPOON restaurant reviewing service, the KUDZU reviewing service, the YELP reviewing service, other reviewing services, and the like.

In other embodiments, social networking functionality is provided by other services, sites, and/or providers that are not explicitly known as social networking providers. For example, some web sites allow users to interact with one another via email, chat services, games, comments, threads, blogs, and/or other means, without explicitly supporting “social networking services.” Examples of such services include, but are not limited to, the WINDOWS LIVE service from Microsoft Corporation in Redmond, Wash., among others. Therefore, it should be appreciated that the above list of social networking services is not exhaustive, as only exemplary social networking services are mentioned herein for the sake of brevity.

In some embodiments, execution of the SN application 110 by the SN server 108 causes the SN server 108 to generate social networking data 112 (“SN data”) associated with the social networking service and/or associated with one or more users of the SN application 110. In other embodiments, the SN server 108 stores or hosts the SN data 112. The SN data 112 can describe, for example, social networking graphs associated with one or more users, communities and/or networks, social networking user content such as status updates, photographs, reviews, links, videos, and the like, contact and biographical information associated with one or more social networking users, and the like.

In some embodiments, the SN data 112 includes, for example, information describing rooms or other aspects of room-based computing environments created or accessed by users of the social networking services, applications 106 and/or other resources accessed by users of the social networking service, shopping and searching histories and preferences associated with users of the social networking service, articles recommended by users of the social networking services, advertisements, web sites, links, photos, video, audio, combinations thereof, and the like. The SN data 112 also can include other information such as likes and dislikes associated with one or more users of the social networking service, comments associated with or generated by one or more users of the social networking service, connection requests associated by or generated by one or more users of the social networking service, and the like. It should be appreciated that the SN data 112 can include any type of social networking information, and that the examples listed above are illustrative.

According to various embodiments, the operating environment 100 includes a search engine 114 operating on or in communication with the network 104. The functionality of the search engine 114 can be provided by one or more applications, which can be executed by one or more devices and/or combinations of devices. In some embodiments, the functionality of the search engine 114 is provided by one or more server computers configured to execute various applications, though this is not necessarily the case.

In the illustrated embodiment, the functionality of the search engine 114 is provided by a web server configured to execute a search application and/or other applications (not illustrated). According to various implementations, the search engine 114 is configured to discover applications 106, SN servers 108, web sites, services, and/or other resources accessible via the network 104, to index the resources, to search the indexed resources, and/or to provide search results that meet or are deemed relevant to search queries and/or other requests for resources. For example, the search engine 114 can be provided to receive, parse, interpret, and execute search queries or other requests, and to provide search results that satisfy and/or are relevant to the queries. As such, it should be understood that the search engine 114 can be configured to apply natural language processing and/or other logic to identify search terms in and/or otherwise interpret search queries.

According to various implementations, search results can be passed to searchers or other entities via search result pages, which can include, for example, links to identified documents, files, applications 106, SN applications 108, and/or other resources, and the like. The search engine 114 also can be configured to track search histories and/or other usage associated with the search engine 114, if desired, for various analytics and/or metrics tracking and reporting, and/or for use in providing services via other nodes or devices in communication with the search engine 114. If the search engine 114 is configured to provide analytics and/or metrics tracking functionality, users can be provided with opportunities to opt-in and/or opt-out of the functionality to address perceived privacy and/or security concerns. Similarly, all usage information can be anonymized before storing or using the information to address security and/or privacy concerns.

According to various embodiments, search data 116 including search results, search histories, browsing and/or other information can be generated or stored by the search engine 114. The search data 116 can be made available to, transmitted to, and/or retrieved by one or more devices in communication with the search engine 114 such as, for example, a room engine 118. Some exemplary uses of the search data 116 are described in more detail herein.

The room engine 118 is configured to provide the functionality described herein for creating room-based computing environments, generating and storing data describing the room-based computing environments, determining and presenting advertising associated with the room-based computing environments, generating and providing user interfaces for interacting with the data describing the room-based computing environments, and the like, as is described herein in detail. In some embodiments, the room engine 118 is configured to execute a room application 120 and an advertising application 122.

The room application 120 is configured to generate collections or bundles of resources and organize the resources into one or more room-based computing environments. The room-based computing environments can include, but are not limited to, one or more rooms. In some embodiments, the rooms represent a particular category or type of resources that are divided in a manner corresponding to rooms of a building. For example, resources can be bundled and/or organized into a number of rooms such as an office, a study, a recreation room, other rooms, and the like, all of which can be generally related to one another.

More particularly, as will be described herein in more detail, the rooms can be categorized into broader or more general categories corresponding to buildings. For example, in one embodiment the rooms are arranged into categories corresponding to buildings, wherein the buildings themselves may contain one or more rooms. The buildings can be used to bundle together related or similar rooms, based upon broader or more general categories of the rooms. For example, rooms devoted to personal use can be arranged into a “home” category of rooms, or other buildings. The related rooms can be accessed via a graphical representation of a home or by other means of accessing the category of resources corresponding to the home. Similarly, rooms devoted to business use can be arranged into an “office” building corresponding to a category of rooms related to business use, and the office building can be accessed via a graphical representation of an office or by other means of accessing the category of resources corresponding to the office.

Additionally, or alternatively, the resources bundled together and/or categorized as or in the rooms can be further categorized or organized into narrower or more particular categories or bundles of resources. In one embodiment the resources of the rooms are arranged into categories corresponding to walls, fixtures, furniture, or other components (“items”) of a room. For example, resources used for personal finance may be arranged into an office room of a home building, and a more particular category of resources, for example checking account balance resolution applications or resources, may be organized into a desk item. The desk item may correspond to a heightened privacy level of the categorized personal financial resources, or to other categories of resources. It should be understood that the office may contain additional and/or alternative items corresponding to other categories of resources.

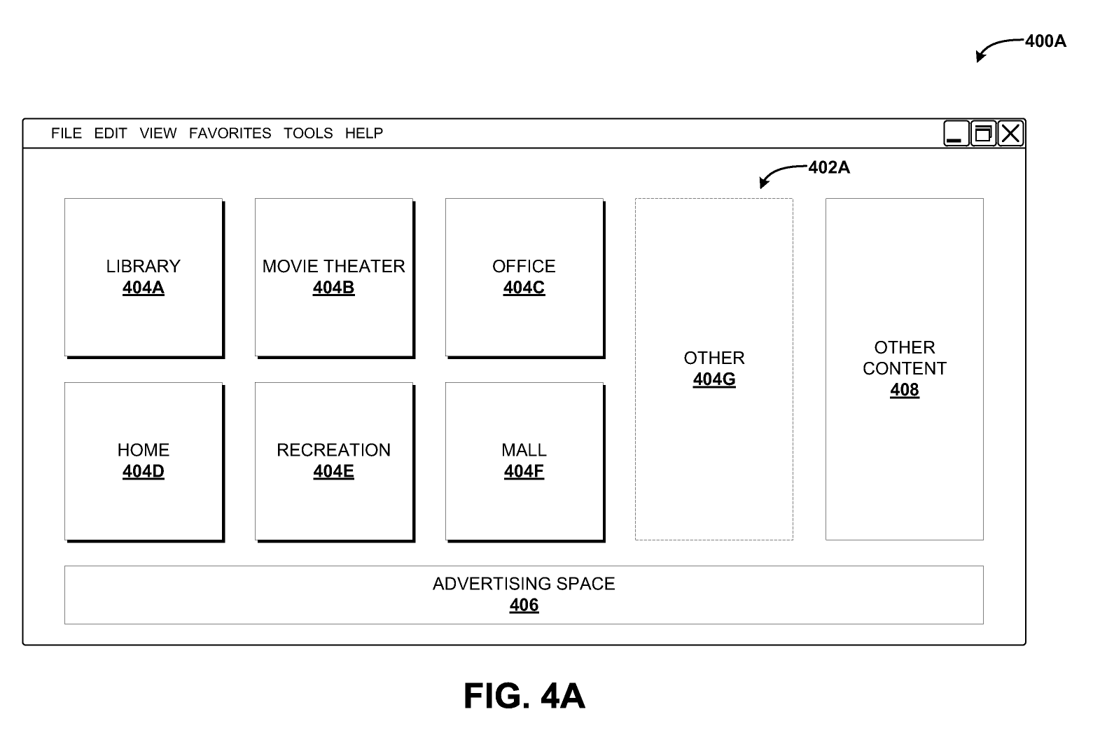

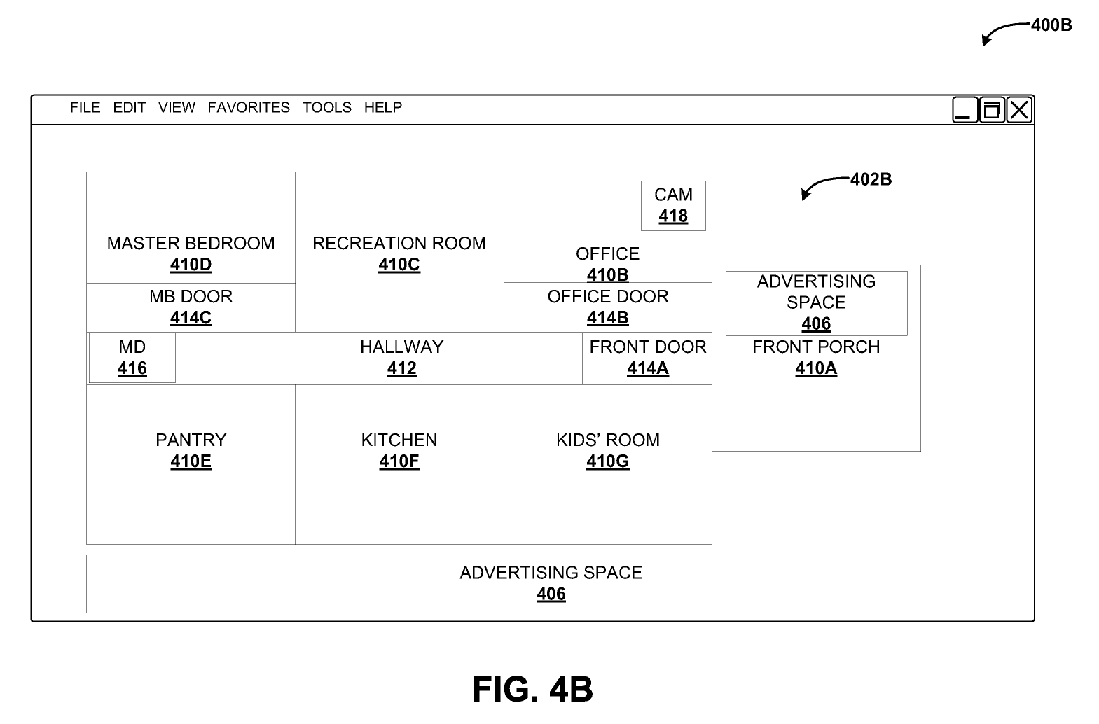

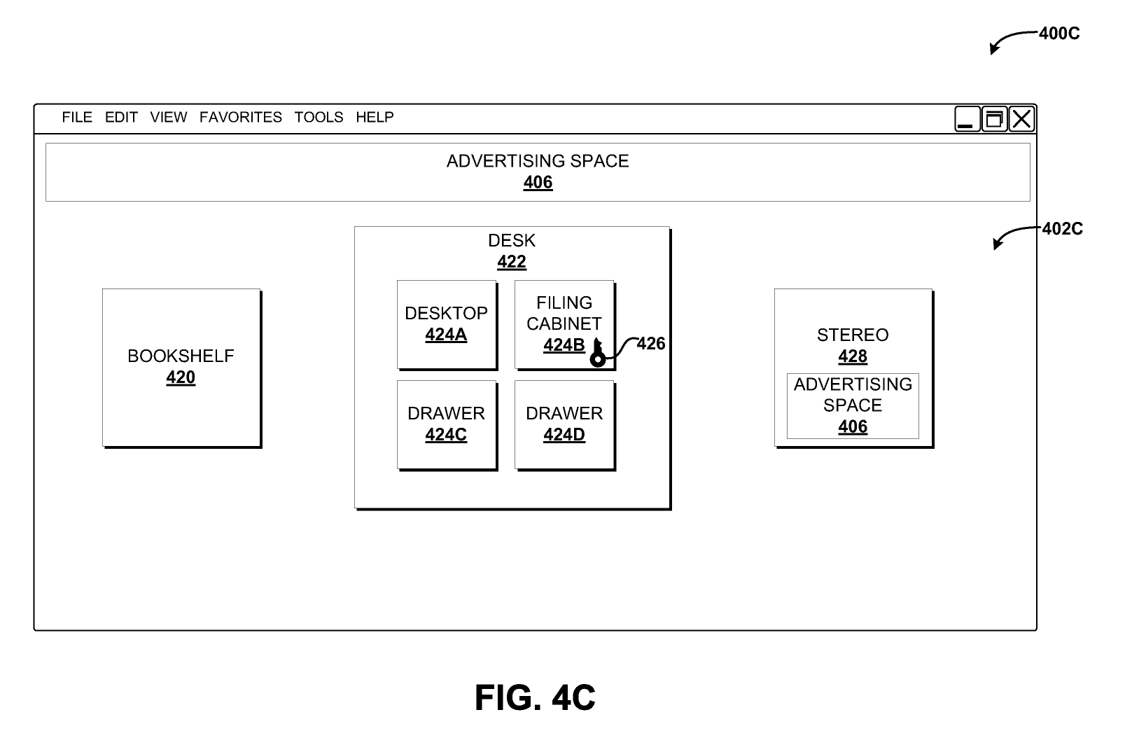

As will be explained in more detail below with reference to FIGS. 4A-4C, permissions can be set for each individual resource, each bundle of resources, each category of bundles of resources, each category of rooms, and the like. As such, the concepts and technologies disclosed herein can be used enable rich permissioning and/or access control functionality for the buildings, rooms, items, and/or other levels of resources. These and other types of buildings, rooms, items, and resources are illustrated and described in more detail below with reference to FIGS. 4A-4C.

In some embodiments, buildings, rooms, or items are accessed via one or more keys that can be shared with users. As used herein, a “key” corresponds to information used by an entity to access one or more aspects of the room-based computing environment such as, for example, a building, a room, an item, a particular resource, and the like. It should be understood that the “key” can be provided by functionality such as tokens, passwords, and the like, and does not necessarily relate to any physical item. Thus, it should be understood that the term “key” can refer not only to functionality, but also to graphical representations of functionality for display and/or interaction with in a room-based computing environment.

In some embodiments, a key to a building can be shared as a password that allows access to a group of rooms corresponding to the building. Thus, a user can share his home category of rooms with other users by sharing a password to enable access to the building. In some embodiments, multiple keys may be needed to access one or more rooms of a particular building and/or items in a particular room. For example, while a particular shared key may enable access to the building, some rooms in the building may not be accessible using the shared key. Users can place additional access control mechanisms in place to prevent access to particular rooms. These access control mechanisms can be graphically represented as doors or locks, and users can be granted keys, passwords, and/or other mechanisms to enable access to rooms or items that are protected by these additional access control mechanisms.

To further illustrate the notion of access control in an exemplary embodiment, consider a home building, or a collection of rooms dedicated to personal use. A user may share his home category of rooms with other users to allow them to access his collection of resources such as web sites, links, pages, and the like. In order to control access to the home category of rooms, the user may require a key to access the home. The other users may access the home via the key, and/or some rooms of the home may be made available via open access to any user accessing the home category of rooms. Upon accessing the home, which can be graphically represented on a UI by walking into a home or otherwise accessing the rooms associated with the home, some rooms may be “locked” or otherwise protected from “entry” or access, and some rooms may be open to any user possessing the key to the front door or other access into the home. To access the protected or locked rooms, a user may need to present another key such as a password or other authentication mechanism to pass the locked door. In other embodiments, users can request entry to the room via email, chat services, telephone, and the like, which can be represented as “knocking” on the locked door, graphically or otherwise. This “knocking” can be used or interpreted to prompt a message or other notification to a user associated with the shared room regarding the requested access.

Similarly, once access is gained to a particular room, some items in the room may be further protected or subject to access control mechanisms. In the case of the home office, it will be appreciated that sensitive financial or personal resources may be categorized into a locking drawer of a desk or other item in the office, while other resources may be categorized into a desktop of the desk that is visible to any users granted access to the office. All of these concepts can be graphically represented and presented to users to allow users to graphically navigate resources, bundles of resources, bundles of bundles of resources, and the like. These and other features of the room-based computing environment described herein are illustrated and described in more detail with reference to FIGS. 4A-4C.

According to various embodiments, the room data 124 includes individual resource information such as one or more links for accessing resources, descriptions of the resources, and the like, data describing the bundled resources that have been defined by users as corresponding to a room, a building, items in rooms, and the like. The room data 124 also can include authentication/permissions lists, passwords, and/or other data associated with individual resources, bundles of resources, categories of resources, and the like. As mentioned above, the resources can include, but are not limited to, applications, web pages, links, services, audio files, video files, web stores, and the like. Thus, it should be understood that resource access via one or more buildings, rooms, items, and the like associated with a user can be restricted by the user, if desired, even if the resources are publicly available via other access means.

The room data 124 also can include computer executable instructions for generating one or more UIs associated with the buildings, rooms, items, resources, and the like. Additionally, the room data 124 can include location data associated with the room-based computing environments. For example, in some embodiments, buildings, rooms, and/or items are associated with real-world location or geolocation data to enable location-based functionality associated with the room-based computing environment. For example, a user may access a room-based computing environment and may by default be placed in a building or room associated with a current geographic location of the user. Thus, a user accessing the room-based computing environment from his home may by default be presented with a graphical UI illustrating his home and/or a room of his home corresponding to his current location. This example is illustrative, and should not be construed as being limiting in any way.

The advertising application 122 is configured to generate advertising 126 to present with, or embed in, the room data 124. In some embodiments, the advertising application 122 generates the advertising 126 in accordance with one or more advertising or marketing plans and/or manages the positioning, placement, and presentation of the advertising 126 in association with and/or independent of the advertising and/or marketing plans. In some embodiments, the advertising application 122 manages subscriptions and/or advertising campaigns for advertisers such as social networking service administrators, application developers, web resource authors or service providers, and the like. According to some implementations, advertisers pay a fee or otherwise participate in advertising services designed to select and present advertising 126 and/or to enhance or improve the presentation of advertising 126 in accordance with marketing and/or advertising plans. Additionally, or alternatively, users can share buildings, rooms, items, and individual resources, and may sell advertising space in the shared buildings, rooms, items, and the like, to advertisers, search engines, or other entities. Exemplary presentation of advertising 126 in buildings, rooms, items, and the like are described in more detail herein.

The operating environment 100 also includes a client 128 operating on or in communication with the network 104. According to various embodiments, the client 128 includes a personal computer (“PC”) such as a desktop, tablet, laptop or netbook computer system. The client 128 also includes, in various implementations, other types of computing systems including, but not limited to, server computers, handheld computers, embedded computer systems, personal digital assistants, mobile telephones, smart phones, set top boxes (“STBs”), gaming devices, and/or other computing devices. Although not illustrated in FIG. 1, it should be understood that the client 128 can communicate with the room engine 118 via the network 104.

The client 128 is configured to execute an operating system 130. According to various embodiments, the operating system 130 executed by the client 128 is a native operating system such as the WINDOWS family of operating systems from Microsoft Corporation of Redmond, Wash. and/or a web-based operating system. Thus, it will be understood that according to various embodiments, the client 128 is configured or equipped to execute traditional native applications and/or programs at the client-side and/or to access applications such as the applications 106, which can include remotely-executed applications such as web applications and/or other remote applications.

Additionally, the client 128 can be configured to receive and render data generated by the applications 106, the SN application 110, the room engine 118, and/or other entities. For example, the client 128 can receive content such as web pages, data generated by applications 106, SN data 112, room data 124, advertising 126, and/or other content, which can be rendered by the operating system 130 or an application program 132 executed by the client 128. In some implementations, the client 128 is configured to access remotely-executed applications and/or to execute local code such as scripts, local searches, and the like. As such, the client 128 can be configured to access or utilize cloud-based, web-based, and/or other remotely executed applications, and to render the data generated by applications 106, SN applications 110, and/or associated with web pages or other resources.

It therefore should be understood that the application programs 132 can include one or more programs for accessing and rendering the room data 124 to provide a graphical representation of the room-based computing environment, as will be explained in more detail herein. It also should be understood that the application programs 132 can include applications for accessing and/or rendering content such as web pages and the like, programs for accessing, executing, and/or rendering data associated with various native and/or web-based applications, and/or programs for accessing, executing, and/or rendering data associated with various services. In other embodiments, the application programs 132 include stand-alone or runtime applications that are configured to access web-based or remote resources and/or applications via public or private application programming interfaces (“APIs”) and/or public or private network connections. Therefore, the application programs 132 can include native and/or web-based applications for providing or rendering data associated with locally-executed and/or remotely-executed applications.

According to various embodiments, a resource such as a web page, an application 106, a document, a multimedia file, and/or other files, a social networking service, and/or another resource is accessed or specified by a user, a device, a node, or the like, and designated for addition to a room or other category or bundle of resources. Notwithstanding conventional usage of words such as organizing, categorizing, bundling, and the like, it should be understood that resources are not necessarily being contiguously located or organized in any particular location. Rather, organizing, categorizing, bundling, and the like, can include identifying groups, bundles, categories, or the like, with which a particular resource is associated. The resource may be categorized or organized into a category or bundle of resources and associated with a new or existing room or other category or bundle of resources. In some embodiments, related rooms can be bundled into a building corresponding to a type of resources. Similarly, rooms can include items that correspond to more narrowly defined categories of resources, relative to the rooms. Data describing the resource, identifying one or more links or locations associated with the resource, and/or other information can be stored as the room data 124 and associated with the particular building, room, item, or other resource bundle or specified resource category.

During creation of a room, access of a room, review of a room, and/or during addition of a resource to a room, various data can be retrieved and associated with the resource, if desired. For example, location data, search history information, social networking information, browsing histories, and the like, can be retrieved by the room engine 118. The data can be used by the room engine 118 to further define the resources and/or tailor functionality associated with the resources. For example, the room engine 118 can associate location data with the resource, as explained above.

The room engine 118 also can access the search data 116 to identify search trends and/or other information associated with the resource, if desired. The search data 116 can identify, for example, popularity and/or ranking information associated with the resource, searching trends associated with the resource, and the like. These and other aspects of the search data 116 can be used to generate advertising 126 for display in a room-based computing environment and can be stored with the room data 124.

A room-based computing environment can be generated. The room-based computing environment can include one or more buildings, one or more rooms in the one or more buildings, one or more items in the one or more rooms, and/or one or more resources associated with the one or more items. Data describing the room-based computing environment, as well as data for generating one or more UIs for navigating the room-based computing environment can be stored with or as the room data 124. Permissions associated with each of the buildings, rooms, items, and/or resources can be specified, if desired, and can be stored as or with the room data 124, if desired.

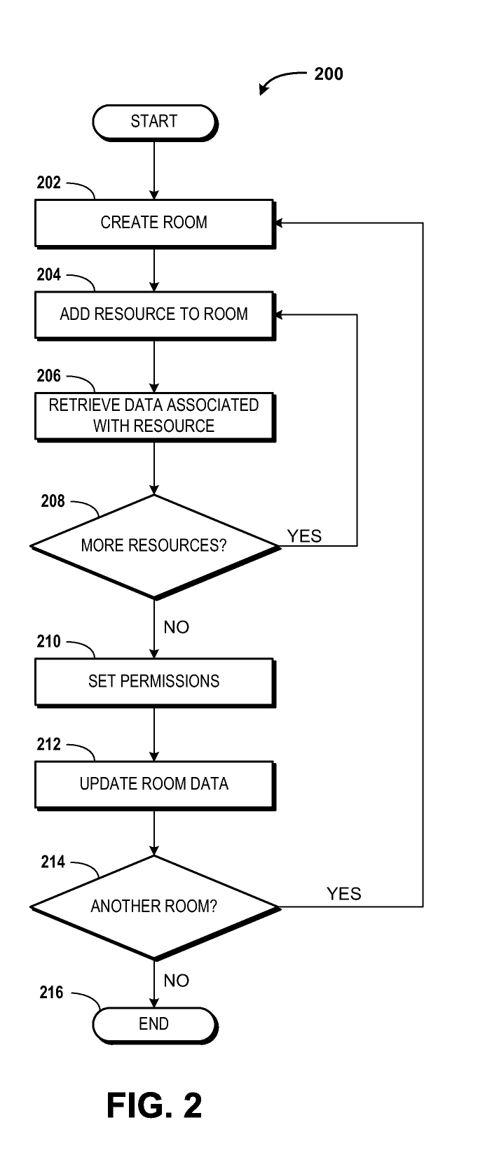

If an entity accesses the room-based computing environment, the room engine 118 can be configured to recognize the access. The room engine 118 also is configured to authenticate the entity to determine access rights to the contents of the room-based computing environment, to generate the contents of the room-based computing environment, including advertising 126 and/or other information associated with the room-based computing environment, and to present the environment to the entity, if appropriate. Exemplary methodology for generating and presenting the room-based computing environment, as well as exemplary UIs for presenting the room-based computing environments, are illustrated and described in more detail with reference to FIGS. 2-4C.

FIG. 1 illustrates one server computer 102, one network 104, one SN server 108, one search engine 114, one room engine 118, and one client 128. It should be understood, however, that some implementations of the operating environment 100 include multiple server computers 102, multiple networks 104, multiple SN servers 108, multiple search engines 114, multiple room engines 118, and/or multiple clients 128. Thus, the illustrated embodiments should be understood as being exemplary, and should not be construed as being limiting in any way.

Turning now to FIG. 2, aspects of a method 200 for generating rooms for a room-based computing environment will be described in detail. It should be understood that the operations of the methods disclosed herein are not necessarily presented in any particular order and that performance of some or all of the operations in an alternative order(s) is possible and is contemplated. The operations have been presented in the demonstrated order for ease of description and illustration, and not for purposes of limiting the disclosure in any way. Operations may be added, omitted, and/or performed simultaneously, without departing from the scope of the appended claims.

It also should be understood that the illustrated methods can be ended at any time and need not be performed in their respective entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof.

For purposes of illustrating and describing the concepts of the present disclosure, the method 200 is described as being performed by the room engine 118 via execution of one or more applications such as, for example, the room application 120 and/or the advertising application 122. It should be understood that this embodiment is exemplary and should not be viewed as being limiting in any way. In particular, one or more additional or alternative devices can execute these and/or other applications without departing from the scope of the disclosure.

The method 200 begins at operation 202, wherein the room engine 118 creates a room. As explained above, a room can include a category of resources. Although not described and/or illustrated in FIG. 2, it should be understood from the disclosure herein that buildings, items, and/or other divisions, sub-divisions, categories, sub-categories, and the like, of resources also can be created in accordance with the concepts and technologies disclosed herein. As such, the illustrated embodiments, wherein the creation of rooms is illustrated and described, should be understood as being exemplary of the disclosure, and should not be construed as being limiting in any way.

According to some embodiments, the room engine 118 can receive input specifying creation of the room. The input can be received from a user, a device, or another entity. The input can be received via one or more user interfaces or API's provided by the room engine 118. For example, the room engine 118 can execute the room application 120 to provide an interface via which input corresponding to creation of rooms is received. A user may access the room engine 118, for example, and create a new “office” room. As explained above, the office room can be created as part of a building of rooms corresponding to a category of rooms and/or independent of categories or other divisions.

From operation 202, the method 200 proceeds to operation 204, wherein one or more resources are associated with the room created in operation 202. As mentioned above, “resources” can include applications, services, and files, as well as data associated with or generated by applications, services, web pages, web sites, files, application data, search data, and/or other information that may be consumed or used by the client 128 and/or other entities. It also should be understood from the disclosure herein that associating the resources with the room can include identifying, generating, and/or storing information specifying how the resources can be accessed.

According to various embodiments, the information includes one or more network links to web pages, files, applications, and/or other resources. Other information for accessing the resources can include names of the resources, hardware and/or software components associated with the resources, and the like. Thus, the information can include, for example, network links such as URLs for accessing the resource and/or data specifying a hardware component that hosts the resource. The above examples of information specifying how the resources are accessed is exemplary, and should not be construed as being limiting in any way.

From operation 204, the method 200 proceeds to operation 206, wherein the room engine 118 retrieves data associated with the resource. The retrieved data can include, but is not limited to, the search data 116, contextual data associated with the resource, location data associated with the resource or the client 128 at a particular time such as when the resource is added to the room-based computing environment, advertising information associated with the resource, ranking information associated with the resource, usage information associated with the resource, and/or other data. For example, the search data 116 can include search histories associated with the resource, wherein the search histories reveal search terms that commonly resulted in display of the resource, numbers of times the resource has been explicitly searched for my name, links to the resource, and the like. These and other types of search data 116 can be used to determine relevance of the resource to particular queries or other activity, as well as to determine popularity of the resource in specific search or activity scenarios.

As mentioned above, location information associated with the resource also can be stored. In some embodiments, the location of the client 128 and/or another device when the resource is added to a room-based computing environment can be associated with the resource. Thus, for example, a resource that is added to a room-based computing environment when searching from a real-world home office may be categorized in a “home-office” category and graphically displayed in a home-office room, as will be more clearly understood with reference to FIGS. 4A-4C. Other uses for location information are possible and are contemplated.

The advertising and/or ranking information can include advertising 126 associated with the resource and/or ranking or placement information associated with the advertising 126 and/or the resource. Thus, for example, the advertising and/or ranking information can indicate how the resource is ranked and/or any advertising programs associated with the resource, if any. This information can be used when presenting the room-based computing environment, as is disclosed in more detail herein.

From operation 206, the method 200 proceeds to operation 208, wherein the room engine 118 determines if additional resources are to be associated with the room. If the room engine 118 determines that additional resources are to be associated with the room, the method 200 returns to operation 204, wherein the resources are associated with the room, and continues back to operation 206, wherein the data associated with the resource is retrieved. The method 200 again proceeds to operation 208, wherein the room engine 118 again determines if more resources are to be added to the room. If the room engine 118 determines in any iteration of operation 208 that additional resources are not to be associated with the room, the method 200 proceeds to operation 210.

At operation 210, the room engine sets permissions associated with the room. In particular, a user or other entity can specify access controls for the room. As explained herein, the access controls can include, for example, passwords or other authentication mechanisms, keys, tokens, cookies, combinations thereof, and the like. The access control information can be generated automatically and/or based upon user input. The creation and use of access control mechanisms is described in more detail herein, particularly with reference to FIGS. 4A-4C.

From operation 210, the method 200 proceeds to operation 212, wherein the room engine 118 updates the room data 124. The room engine 118 can add or modify the room data 124 to reflect the room created and/or modified in the operations 202-210, as well as the resources associated with the room. Furthermore, the room data 124 can be updated to reflect the permissions and/or access control information determined in operation 210, if any.

From operation 210, the method 200 proceeds to operation 214, wherein the room engine 118 determines if another room is to be created. If the room engine 118 determines that another room is to be created, the method 200 returns to operation 202, wherein another room is created. The operations 202-212 can be repeated for the new room in a manner substantially similar to that described above. If the room engine 118 determines that another room is not to be created, the method 200 proceeds to operation 216. The method 200 ends at operation 216.

As mentioned above, the method 200 can include additional steps for creating buildings. According to one contemplated embodiment, the method 200 can include an operation 201 (not illustrated), which can be provided before the operation 202. In the exemplary operation 201, the room engine 118 receives a command to create a building, and proceeds to operations 202-214 wherein the building is filled with rooms and resources associated therewith. In the exemplary embodiment, the method 200 also includes an operation 215 (not illustrated), which can be provided after the operation 214. At the exemplary operation 215, the room engine 118 determines if another building is to be created, and the method 200 returns to the exemplary operation 201 if the room engine 118 so determines In another embodiment, the room engine 118 is configured to create buildings at any time, including via separate and/or distinct methodology for creating buildings. The room engine 118 can be used to populate the created buildings with existing or newly created rooms. These embodiments therefore should be recognized as being exemplary and should not be construed as being limiting in any way.

Similarly, as mentioned above and as is described in more detail herein with reference to FIGS. 4A-4C, the rooms can be populated with items represented by fixtures, furniture, or the like, which can correspond to categories, subcategories, divisions, subdivisions, and the like, of resources. Thus, the method 200 can include additional steps for creating items and/or the room engine 118 can execute other methodology to provide functionality for creating room items and/or for associating items with particular rooms. In one contemplated embodiment, the method 200 includes an operation 203 (not illustrated) that can be provided after the operation 202. In the exemplary operation 203, the room engine 118 receives a command to create an item associated the room, and proceeds to operations 204-208, wherein resources are associated with or added to the item created in operation 203. In the exemplary embodiment, the method 200 also includes an operation 209, wherein the room engine 118 determines if another item is to be created. If another item is to be created, the method 200 returns to operation 203 and the new item is created. If not, the method 200 proceeds to operation 210, as described above.

Although not illustrated or described with reference to FIG. 2, it should be understood that the permissions setting functionality associated with the operation 210 can be provided collectively and/or individually for buildings, items, and/or other categories, subcategories, divisions, and/or subdivisions of resources created by the room engine 118. Thus, as will be described in more detail below, users or other entities can specify multiple identical, similar, and/or varied layers of security and/or access controls for accessing particular buildings, rooms, items, individual resources, and the like. It should be understood that various rooms can be grouped together and subject to similar or identical access control policies, if desired. Furthermore, parties attempting to access a particular building, room, item, individual resource, or the like, may be required to satisfy several layers of security and/or access control functionality.

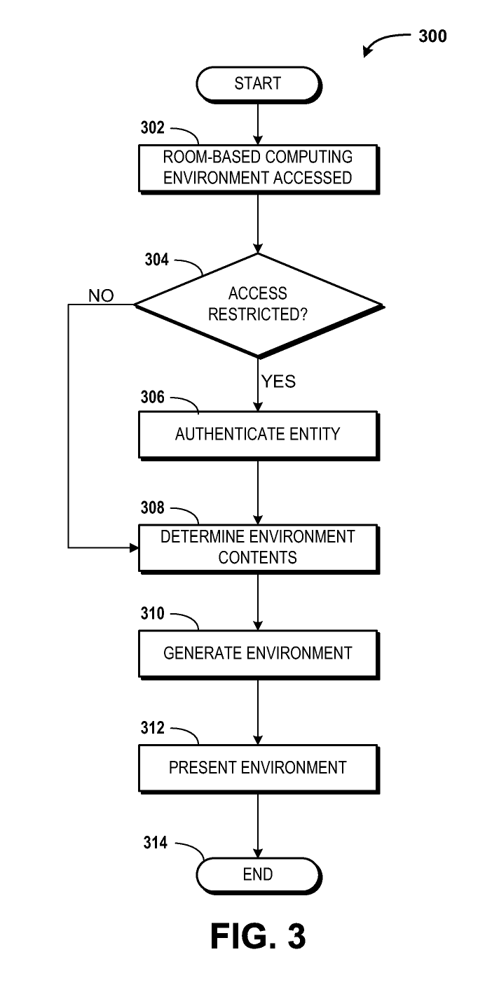

Turning now to FIG. 3, a method 300 for providing access to a room-based computing environment is described in detail, according to an exemplary embodiment. For purposes of illustration, and not limitation, the method 300 is described as being performed by the room engine 118. It should be understood that this embodiment is exemplary, and should not be construed as being limiting in any way. Other devices and/or applications can be used to generate the room-based computing environment without departing from the scope of the claims.

The method 300 begins at operation 302, wherein the room-based computing environment is accessed. In some embodiments, the room-based computing environment may be accessed via access of one or more rooms of the room-based computing environment. According to some embodiments, the room-based computing environment is accessed via the room engine 118. As such, the room engine 118 can be configured to detect when the room-based computing environment is accessed, though this is not necessarily the case. In other embodiments, the room-based computing environment generated based upon room data 124 stored at or accessed by the room engine 118 and access therefore can be determined based upon access of the room data 124. It should be understood that these methods for recognizing access of the room-based computing environment are exemplary, and should not be construed as being limiting in any way.

From operation 302, the method 300 proceeds to operation 304, wherein the room engine 118 determines if the room-based computing environment accessed in operation 302 is subject to access control restrictions. As mentioned above, users or other entities can specify one or more access control mechanisms for various components of the room-based computing environment such as buildings, rooms, items, and the like. Similarly, the one or more access control mechanisms can include, for example, passwords, tokens, keys, certificates, and/or other authentication mechanisms. Thus, the operation 304 can include a determination by the room engine 118 if any access controls are associated with the room-based computing environment. If the room engine 118 determines that access control mechanisms are associated with the room-based computing environment, the method 300 proceeds to operation 306.

At operation 306, the room engine 118 authenticates the entity accessing the room-based computing environment. According to various embodiments, the room engine 118 is configured to interact with the entity in various manners to provide the authentication functionality of the room engine 118. For example, in some embodiments, the room engine 118 generates a UI for presenting a login window or form to the entity. The UI can prompt the entity for a user ID, password, and/or other information to gain access to the room-based computing environment.

In other embodiments, the room engine 118 prompts the entity for a “key” to the room-based computing environment, and/or a component thereof such as a building, a room, an item, and the like. The functionality of the “key” can be provided by way of an access code, a token, and/or other authentication means. In yet other embodiments, the room engine 118 determines if the entity is entitled to access the room-based computing environment based, at least partially, upon one or more device identifiers associated with the entity, one or more access lists associated with the room, and/or other information. It should be understood that the above authentication methods are exemplary, and that additional, alternative, and/or combinations of these and other authentication methods are possible and are contemplated.

From operation 306, or from operation 304 if the room engine 118 determines that access to the room-based computing environment is not restricted, the method 300 proceeds to operation 308, wherein the room engine determines the contents of the room-based computing environment. According to various embodiments, the room engine 118 accesses the room data 124 and determines what elements of the room-based computing environment should be presented to the entity. If any components of the room-based computing environment are subject to access controls, the room engine 118 can apply an access control policy to the room data 124 to restrict the presented room data 124 to only that data to which the entity accessing the room-based computing environment has authority to view.

Thus, if two users access the same room data 124, but user1 is entitled to access, for example, a home office of a home building whereas user2 is not entitled to view the home office of a home building, the room engine 118 can omit the room data 124 corresponding to the home office before presenting the room-based computing environment to user2, but may include the room data 124 corresponding to the home office when presenting the room-based computing environment to user1. This example is illustrative of how the content of the room-based computing environment can be altered based upon access control rights, and should not be construed as being limiting in any way.

Furthermore, it should be understood that users who fail to properly authenticate with the room engine 118 may or may not be made ware of such failure, depending upon security policies associated with the room-based computing environment. In some embodiments, the users who fail to properly authenticate are still presented with the room-based computing environment, but those components of the room-based computing environment to which access is restricted by one or more polices are omitted from the room-based computing environment presented to the entity. As such, the entity may not know that authentication has failed and therefore may not make further attempts at accessing the restricted information. In some embodiments, this approach improves the overall security of the room-based computing environment and therefore is adopted, while in other embodiments the entities are presented with the ability to authenticate more than once and/or are otherwise notified that authentication has failed.

Determining the environment contents of the room-based computing environment further can include generating advertising for display with or in the room-based computing environment. For example, some entities may pay a fee to have advertising 126 displayed in room-based computing environments associated with particular users. Additionally, or alternatively, users may sell advertising space in room-based computing environments to advertising entities in an attempt to generate revenue based upon the shared room-based computing environments. As explained herein, advertising content, the placement thereof, and the ranking and generation thereof, can be determined based upon the search data 116, the SN data 112, contextual information associated with the client 128, and/or other information.

In some embodiments, access of a particular building, room, and/or item in a room-based computing environment can prompt generation or display of advertising 126. For example, if an entity accesses a kitchen room of a room-based computing environment, advertising 126 relating to kitchen accessories or appliances, foods, groceries, and/or ingredients, cook books, and the like, can be displayed in an attempt sell goods or services to the entity. This example is illustrative and should not be construed as being limiting in any way. It will thus be understood that accessing particular buildings, rooms, and/or items can trigger the display of various advertising 126 believed to be relevant to the buildings, rooms, and/or items.

From operation 308, the method 300 proceeds to operation 310, wherein the room engine 118 generates the room-based computing environment based upon the contents determined in operation 310. Although not specifically illustrated or described in detail in FIG. 3, it should be understood from the disclosure herein that generating the room-based computing environment can include generating one or buildings, one or more rooms, one or more items, and/or other categories, subcategories, divisions, subdivisions, and the like, of resources. It also should be understood that generating the room-based computing environment can include generating one or more user interfaces for interacting with the room data 124, as will be described in more detail below with reference to FIGS. 4A-4C.

From operation 310, the method 300 proceeds to operation 312, wherein the room engine 118 presents the room-based computing environment. As will be appreciated in light of the description above of operation 308, presenting the room-based computing environment can include presenting the advertising 126 to the entity. Furthermore, presenting the room-based computing environment also can include prompting an entity for additional login or other access control information, as is explained in more detail herein. The method 300 ends at operation 314.

Turning now to FIG. 4A, a user interface diagram showing aspects of a user interface (UI) for displaying a room-based computing environment in one embodiment will be described. In particular, FIG. 4A shows a screen display 400A generated by one or more of the OS 130 and/or the application programs 132 executed by the client 128 according to one particular implementation presented herein. It should be appreciated that the UI diagrams illustrated in FIGS. 4A-4C are exemplary. Furthermore, it should be understood that data corresponding to the UI diagrams illustrated in FIGS. 4A-4C can be generated by the room engine 118 and rendered by the client 128, though this is not necessarily the case.

The data corresponding to the UI diagrams illustrated in FIGS. 4A-4C also can be generated via execution of a web-based application that is executed by the client 128, executed by a system remote from the client 128, and/or executed by a combination of the client 128 and a system remote from the client 128. Similarly, as explained above, the UI can be executed by a system remote from the client 128, and data corresponding to the executed UI can be transmitted to or made available to the client 128 for rendering and display at the client 128. As such, the UI diagrams can be displayed at a client 128 executing a web-based operating system and/or other operating systems.

The screen display 400A shown in FIG. 4A includes various tool bar and menu items. It should be understood that the illustrated tool bar and menu items are merely illustrative, and that additional and/or alternative tool bar and/or menu items are possible and are contemplated. In the illustrated embodiment, the screen display 400A includes a navigational display 402A. The navigational display 402A can be a visual representation generated based upon the room data 124 and the advertising 126 as described herein. In the illustrated embodiment, the navigational display 402A displays UI controls 404A-H (collectively referred to herein as one or more “UI controls 404”) for accessing buildings as described above. According to exemplary embodiments, selection of one or more of the UI controls 404 causes the client 128 to display additional details associated with the building, for example, by displaying one or more rooms associated with the building.

In the illustrated embodiment, the navigational display 402A includes a UI control 404A for accessing a library building, which can contain one or more rooms relating to research, study, reading, and/or other activities sometimes associated with physical libraries. The navigational display 402A also includes a UI control 404B for accessing a movie theater building, which can contain one or more rooms relating to video or movies such as streaming video applications, movie research sites, movie theatre web sites, and the like, as well as other resources for accessing functionality sometimes associated with physical movie theatres. The navigational display 402A also includes a UI control 404C for accessing an office building, which can contain one or more rooms relating to a user's business such as a business web site, business tools and/or applications, business banking information, intranet sites, and the like, as well as other resources for accessing functionality sometimes associated with businesses.

The navigational display 402A also includes a UI control 404D for accessing a home building, which can contain one or more rooms relating to a user's personal use such as shopping sites, personal finance sites, news sites, personal banking applications, communication applications and sites, electronic mail service portals, social networking access sites or applications, and/or other resources or applications associated with a user's or other entity's personal use. The navigational display 402A also includes a UI control 404E for accessing a recreation building, which can contain one or more rooms relating to a user's recreational use such as web sites related to hobbies or interests, applications such as games and the like, sports sites and/or streaming video, and/or other resources or applications associated with recreational use.

The navigational display 402A also includes a UI control 404F for accessing a mall building, which can contain one or more rooms relating to shopping and/or sales such as retailer web sites, product reviews, Internet shopping sites, and/or other resources or applications sometimes associated with shopping or retailers. The navigational display 402A also includes a UI control 404G for accessing other buildings. It should be understood that the illustrated navigational display 402A and the illustrated UI controls 404 are illustrative, and should not be construed as being limiting in any way.

The navigational display 402A also includes advertising space 406, which can be used to display advertisements such as, for example, the advertising 126 described herein. It should be understood that the size, orientation, and positioning of the advertising space 406 is illustrative, and that advertisements can be displayed on the UI controls 404, in other spaces on the navigational display, in new, popup, and/or popunder windows, and/or elsewhere on the screen display 400A.

The navigational display 402A also includes an other content area 408, which can be used to display any desired content associated with or related to the room-based computing environment, as well as content unassociated with and/or unrelated to the room-based computing environment. For example, the other content area 408 can display search results generated by the search engine 112, wherein the search results are generated based upon the content of the buildings or rooms, the author of the buildings or rooms, social networking information associated with one or more users associated with the room-based computing environment, and/or other content. In some embodiments, users who author the room-based computing environment configure the other content area 408 to display desired content or information such as sports scores, news, user information, and the like. It should be understood that these examples of content are illustrative, and should not be construed as being limiting in any way. Furthermore, it should be understood that the size, orientation, and positioning of the other content area 408 is illustrative, and that other configurations are possible.

Turning now to FIG. 4B, a user interface diagram showing additional aspects of a user interface (UI) for displaying a room-based computing environment in one embodiment will be described. In particular, FIG. 4B shows a screen display 400B generated by the OS 130 and/or the application programs 132 executed by the client 128 according to one particular implementation presented herein. In the illustrated embodiment, the screen display 400B is displaying a navigational display 402B that is displaying rooms corresponding to a home building. It should be understood that the navigational display 402B may be displayed in response to selection of the UI control 404D described above with reference to FIG. 4A, though this is not necessarily the case. This embodiment is illustrative, as the navigational display 402B can be displayed in response to other actions and/or by default, based upon location data, settings, login information, keys, and the like.

The navigational display 402B includes UI controls 410A-G (hereinafter collectively referred to as “UI controls 410”). Selection of the UI controls 410 can cause the client 128 to display information associated with one or more rooms. In the illustrated embodiment, selection of the UI controls 410 causes the client 128 to display information associated with one or more rooms corresponding to the home building described above with reference to FIG. 4A. This embodiment is illustrative, and should not be construed as being limiting in any way.

The navigational display 402B includes a UI control 410A for accessing a front porch room. The front porch room can include any information that a user associated with the front porch room wishes to share about himself or herself, as well as resources that the user wishes to make available to anyone accessing the home building. In some embodiments, the front porch room includes social networking profiles, contact information, biographical information, and the like, associated with the home building. According to various embodiments, the front porch room is accessible by any user and/or by users given access to the room-based computing environment. According to other embodiments, authentication is required before users can view the contents of the front porch room. In some embodiments, one or more entities associated with the front porch room sells advertising space 406, which can be displayed anywhere on the screen display 400B including, but not limited to, the front porch room, or elsewhere on the navigational display 402B as shown in FIG. 4B.

The navigational display 402B also includes a UI control 410B for accessing an office room. The office room can include any resources or information the user associates with the office room. For example, the office room can include applications for managing finances, paying bills, managing assets, and the like, as well as links to banking or financial institutions, business supply sites, private documents and/or files, and the like. The navigational display 402B also includes a UI control 410C for accessing a recreation room. The recreation room can include any resources or information the user associates with the recreation room such as, for example, links to sports or news sites, applications or links to streaming audio, video, or other multimedia, video rental sites, hobby sites or information, and the like.

The navigational display 402B also includes a UI control 410D for accessing a master bedroom. The master bedroom can include any resources or information the user associates with the master bedroom. For example, the master bedroom may include personal information and/or applications for accessing personal information, image viewing or editing sites or applications, private documents and/or files, and the like. The navigational display 402B also includes a UI control 410E for accessing a pantry room. The pantry room can include any resources or information the user associates with the pantry room such as, for example, links to grocery purchasing sites, links to food or grocery reviews and information, shopping and ordering sites, applications or sites for obtaining nutritional information, and the like.

The navigational display 402B also includes a UI control 410F for accessing a kitchen room. The kitchen room can include any resources or information the user associates with the kitchen room such as, for example, links or applications for recipes or recipe sites, links to streaming video related to cooking, kitchen supply stores or web sites, kitchen product reviews, and the like. The navigational display 402B also includes a UI control 410G for accessing a kids' room. The kids' room can include any resources or information the user associates with the kids' room such as, for example, links to children's games, education applications, reading sites, and the like. The above examples are illustrative, and should not be construed as being limiting in any way. Other rooms and/or categories of resources are contemplated, but are not illustrated and/or described herein in detail for the sake of brevity.

As illustrated in FIG. 4B, the rooms can be joined to one another by a hallway, which also can correspond to a room. For example, selection of a UI control 412 corresponding to the hallway may cause the client 128 to display resources or information that the user makes available for anyone who gains access to the hallway. More particularly, access to the hallway room can be limited by access controls, schematically illustrated in FIG. 4B as UI control 414A corresponding to a front door 414A. Selection of the UI control 414A can cause the client 128 to display a form for prompting for and receiving a password or other authentication information. As explained above, the user associated with the home building can share a key with other users for accessing the hallway and/or other components of the room-based computing environment.

The illustrated home building includes other UI controls 414B-C representing other doors or access controls associated with other rooms illustrated in FIG. 4B. As explained above, keys shared with users may allow the users to access some, all, or none of the rooms associated with a particular building. As such, multiple keys or other access control information may be shared with a user to enable the user to access one or more rooms of a particular building.

The navigational display also includes a UI control 416 for accessing a motion detector (“MD”) in the hallway. In some embodiments, the UI control 416 merely indicates that motion detector functionality is associated with the hallway. More particularly, any access to the hallway, for example, any user successfully authenticating at the front door and thereby accessing the hallway and/or open-access rooms accessible via the hallway, may be reported to a user associated with the rooms and/or the building. The reporting may be by way of instant message, text message, email, news ticker, or the like. Selection of the UI control 416 by authorized entities may present the authorized entities with options relating to the motion detector such as turning the motion detector on or off, setting what types of users trigger the motion detector, what room the motion detector is located in, and the like. In some embodiments, the motion detector functionality is used to provide “hit-counter” functionality for the hallway and/or other rooms in which a motion detector is located. Thus, the motion detector can be used to track traffic in the hallway, if desired.

The navigational display also includes a UI control 418 for accessing a camera (“CAM”) associated with a particular room or building. In some embodiments, the UI control 418 merely indicates that camera functionality is associated with a particular room. More particularly, the camera may provide information to authorized entities, the information indicating who is currently accessing a room that includes the camera functionality and the like. Selection of the UI control 418 by authorized entities may present the authorized entities with options relating to the camera such as turning the camera on or off, setting what users or types of users are reported by the camera functionality, what room the camera functionality applies to, and the like. It should be understood that the functionality of the camera and the motion detector can be combined into a unitary module, if desired.

As explained above with reference to FIG. 4A, advertising space 406 can be provided in one or more of the rooms illustrated in FIG. 4B and/or elsewhere on the screen display 400B, and can be configured in any desired manner. Furthermore, it should be understood that users associated with the rooms can be paid for allowing display of advertisements in association with the rooms, for each click and/or other access of resources associated with the advertisements, and the like. It should be understood that all of the above-described rooms, doors, hallways, and functionality associated with the motion detector and the camera are exemplary, and that these embodiments are illustrative of some of the concepts and technologies disclosed herein. Furthermore, it should be understood, as explained above with reference to FIG. 3, that some, all, or none of the illustrated resources, doors, rooms, and the like may be displayed to users based upon various access controls. For example, if a user does not have authority to access the office room, the office room may be omitted from the display 400B. Alternatively, the door associated with the office may be displayed and may be interacted with to indicate to an authorized entity that the user wishes to obtain authorization to access the office, an indication that may be passed to an authorized party for action.

Turning now to FIG. 4C, a user interface diagram showing additional aspects of a user interface (UI) for displaying a room-based computing environment in one embodiment will be described. In particular, FIG. 4C shows a screen display 400C generated by the OS 130 and/or the application programs 132 executed by the client 128 according to one particular implementation presented herein. In the illustrated embodiment, the screen display 400C is displaying a navigational display 402C corresponding to the office room of the home building, according to an exemplary embodiments.

It should be understood that the navigational display 402C may be displayed in response to selection of the UI 410B corresponding to the home building in FIG. 4B. This embodiment is illustrative, as the navigational display 402C can be displayed in response to other actions and/or by default. For example, in some embodiments, the navigational display 402C is displayed in response to determining that a user is accessing the room-based computing environment from a home office with which the office room is associated. The location can be determined based upon proximity sensors, geolocation information, global position system (GPS) receivers or other location determination devices, and the like. Similarly, the location can be approximated or determined by one or more IP addresses, MAC addresses, or other device identifiers, and the like, as explained above. Other embodiments are possible and are contemplated.

The navigational display 402C includes various UI controls corresponding to one or more resources, as explained above with reference to FIGS. 1-4B. For example, the navigation display 402C includes a UI control 420 for accessing a bookshelf item. In an exemplary embodiment, the bookshelf item is used by a user to provide additional categorization/subcategorization of various resources associated with the buildings and/or rooms described herein. For example, selection of the UI control 420 can cause the client 128 to display articles, books, reference materials, and the like, any or all of which may be associated with an office bookshelf

The navigational display 402C also includes a UI control 422 for accessing a desk item. As mentioned above with regard to FIG. 1, resources may be associated not only with a building, room, and/or an item, but also with components of the item. In an exemplary embodiment, the desk item can be used by a user to provide additional categorization/subcategorization of various resources associated with the buildings and/or rooms described herein, and in particular with the desk item. For example, selection of the UI control 422 can cause the client 128 to display all resources associated with the desk such as financial information, personal records, documents, and the like. In other embodiments, selection of the UI control 422 may cause the client 128 to display all subitems associated with the item. In the illustrated embodiment, the subitems are displayed by default upon accessing the desk office room. It should be understood that this embodiment is exemplary.

In the illustrated embodiment, the desk item includes UI controls 424A-D for accessing various subcategories of resources associated with the desk category. The navigational display 402C includes a UI control 424A for accessing a desktop associated with the desk item. Selection of the UI control 424A can cause the client 128 to display information shared with all users who are authorized to access the office room. For example, home business information, personal and/or home business contact information, and the like, can be shared with all users who obtain authorized access to the office room.

The desk item also includes a UI control 424B for accessing a filing cabinet subcategory of resources. Selection of the UI control 424B can cause the client 128 to display resources categorized in the filing cabinet subcategory. In an exemplary embodiment, tax records, personal records, business records, applications for accessing personal or business information, and the like, are subcategorized in the filing cabinet subcategory and accessible via selection of the UI control 424B. It should be understood that access to the filing cabinet subcategory can be limited to users who successfully authenticate after selection of the UI control 424B and/or who possess a key that allows unlimited access to the buildings, rooms, or items of the room-based computing environment. In FIG. 4C, this is illustrated by a key icon 426 illustrated on the filing cabinet item. It should be understood that other indications are possible and are contemplated. Similarly, the desk item includes UI controls 424C-D for accessing desk drawers, which can include various resources and/or information categorized in the desk drawer or locking desk drawer categories. Similarly, access of the desk drawer subcategories of resources may require authentication, as explained above.

The desk item also includes a UI control 428 for accessing a stereo subcategory of resources. Selection of the UI control 428 can cause the client 128 to display resources categorized in the stereo subcategory. In an exemplary embodiment, streaming audio, streaming video, video or audio files, dictated files, and the like, are subcategorized in the stereo subcategory and accessible via selection of the UI control 428. A user may specify certain music that should play when the UI control 426 is selected, if desired. It should be understood that other embodiments are possible and are contemplated.

As explained above with reference to FIGS. 4A-4B, advertising space 406 can be provided in association with one or more of the items illustrated in FIG. 4C, and can be configured in any desired manner. Furthermore, it should be understood that users associated with the rooms or items can be paid for allowing display of advertisements in association with the rooms or items, for each click or access of resources associated with the advertisements, and the like. It should be understood that all of the above-described items and subitems are exemplary, and that these embodiments are illustrative of some of the concepts and technologies disclosed herein. Furthermore, as mentioned above, some, all, or none of the illustrated items and/or subitems, and the like may be displayed to users based upon various access controls. For example, if a user does not have authority to access the filing cabinet category of resources, the filing cabinet resource may be omitted from the display 400C.

In some embodiments, the room-based computing environment is presented in three-dimensional user interfaces. These interfaces can be, but are not necessarily, provided by extremely realistic and/or immersive graphics. Furthermore, the interfaces can be provided on two-dimensional displays and/or make use of three-dimensional display and viewing technologies. In one contemplated embodiment, a user embarks on a virtual walkthrough in a city or town and arrives at various buildings. The user can approach the doors to enter the buildings and/or present his or her credentials such as a key or authentication information, to gain access to the building. The rooms and items in the rooms also can be rendered to provide realistic and/or immersive interactions with the rooms and the items in the rooms. It therefore will be appreciated that the user experience can be provided in two dimensions and three dimensions.

Providing the room-based computing environment in three dimensions also creates new advertising placement opportunities. For example, in one embodiment, advertisers can buy walls of a room, posters on the walls of a room, and the like, for advertising space. A user navigating through a building or room may see a poster advertising a particular service, company, store, resource, and the like. The advertising 126 may be interacted with in the environment and interactions with the advertising 126 may prompt additional actions such as opening a new room, going to a store associated with the advertiser, and the like. In some embodiments, advertisers offer keys to restricted rooms and the like, if the advertisements are clicked on in room. Similarly, in some embodiments advertisers provide free keys to rooms that are normally fee-based rooms, thereby encouraging users to entertain a trial of the rooms. In some embodiments, free keys persist during a session but are cleared at the end of the session if not accepted or used by the user.

In another embodiment, the room engine 118 is configured to provide room prototypes and/or to provide default objects in particular rooms and/or types of rooms. For example, a room for beer making may be provided by a prototype beer making room. The prototype beer making room may include resources that are selected by the room engine 118 based upon various criteria and/or based upon an anticipated relevance to the subject matter of the room. In one embodiment, the room engine 118 receives the search data 116 and/or access the search engine 114 to determine the most popular resources for beer making The most popular resources may include, for example, reference books or sites, calculators for calculating various aspects of brewed beer such as utilization or international bitterness units (“IBUs”), and the like. The default resources also can be selected on the basis of paid advertising and/or ranking programs, wherein application developers or web site authors pay to have their resources or other content included in the default rooms. These examples are illustrative, and should not be construed as being limiting in any way.

As explained above, the room engine 118 is configured to use location data to alter the presentation of the room data 124 and/or the contents of the rooms. In some embodiments, the room engine 118 uses the location data to alter the UI presented to a user for interacting with rooms. For example, the room engine 118 can determine that a user is accessing the room-based computing environment with a cell phone or other portable computing device. In response to making this determination, the room engine 118 can generate a UI overlay and make the UI overlay available to the portable device. Thus, the room engine 118 can allow portable devices to view the room-based computing environment in modified forms tailored for display on the portable devices.

In another embodiment, the UI overlay is configured to be overlaid on a real time image captured with a camera of a portable device. Thus, for example, a user may be prompted to approach a poster on a wall in a store. In some embodiments, the poster may include a smart tag, a 2D barcode, and/or other information that can be scanned or input into the portable device and used to access a UI overlay such as that described above. Once the UI overlay is received at the portable device, it may be overlaid on the camera image and thereby used to provide, for example, a map for navigating the store, information regarding sales or coupons, applications or tools for improving the shopping experience, tools for paging associates of the store, and the like. Because the location of the user is known at the time the tag or other information from the display in the store is input or scanned, a location-based UI overlay can be provided that includes visual cues for navigating the store. These examples are illustrative, and should not be construed as being limiting in any way.

In some embodiments, the buildings, rooms, and/or items can be versioned and/or provided in multiple versions. Thus, users can access present or past versions of buildings, rooms, items, and the like. Usage of present and/or past versions can be tracked and used to affect ranks associated with the respective versions and/or the rooms across the various versions. In some embodiments, new versions of rooms may be offered for a fee and/or associated with premium advertising space, while older versions may be offered for free or reduced prices and/or associated with less than premium advertising space.

As explained above, the determination as to what resources to include in rooms, and/or how to rank rooms may be determined, in full or in part, based upon page ranking of the rooms and/or resources associated with the rooms. In one implementation, page ranking is also used to compile super-rooms from available resources and/or rooms. The room engine 118 is configured to identify the top-ranked resources and/or rooms, and to compile the most popular rooms and/or resources into a super-room that is expected to be extremely relevant to users searching for rooms and/or search results directed to topics associated with the super-rooms. Advertising space in super-rooms may be offered at a premium price due to the expected traffic and/or usage of the resources included in the super-room, though this is not necessarily the case. It should be understood that other uses for super-rooms, and other ranking and advertising schemes for and in super-rooms are possible and are contemplated.

While the above description has described buildings, rooms, and items, it should be understood that other divisions of resource categories are possible and are contemplated. In one contemplated embodiment, the categories relate to portions of an automobile such as a passenger compartment, the engine, the glove compartment, and the trunk. A key can be provided to a user for accessing the vehicle, including any locked compartments of the vehicle, if desired. Similarly, a “valet-key” can be provided to an entity for accessing only the doors of the vehicle. Thus, access to some parts of the vehicle can be granted, while access to other parts of the vehicle can be restricted.

Similarly, the engine can correspond to logic for running a business such as database querying resources, employee and/or customer data, and the like, while the passenger compartment can correspond to resources accessible by all users such as ordering pages, company information pages, and the like. Thus, the engine compartment, the passenger compartment, the glove compartment, and the trunk can correspond to rooms, and particular aspects of each of those rooms can be categorized as items or stored as resources. This example is illustrative, and should not be construed as being limiting in any way.

Although not described herein in detail, it also should be understood that a room-based computing environment can be used to display peripheral information that is not necessarily directly relevant to a particular room, building, item, or the like being explored or displayed. Thus, for example, the room-based computing environment can be extended to display information in a perspective view, or otherwise to display supplemental information. In some embodiments, for example, weather information is visible through windows of a room-based computing environment. Similarly, social network status, email and/or messaging information, news, stock quotes, and the like can be displayed in the room-based computing environment. As used in the claims, the term “peripheral information” is used to refer to information that is not necessarily directly relevant to a particular building, room, or item, but is of interest to a user of the room-based computing environment. In one contemplated embodiment, peripheral information is displayed on a wall of a room, on a desktop of a desk item in a room, on a wall of a building, or elsewhere in a room-based computing environment. It should be understood that the above-provided examples are illustrative and should not be construed as being limiting in any way.

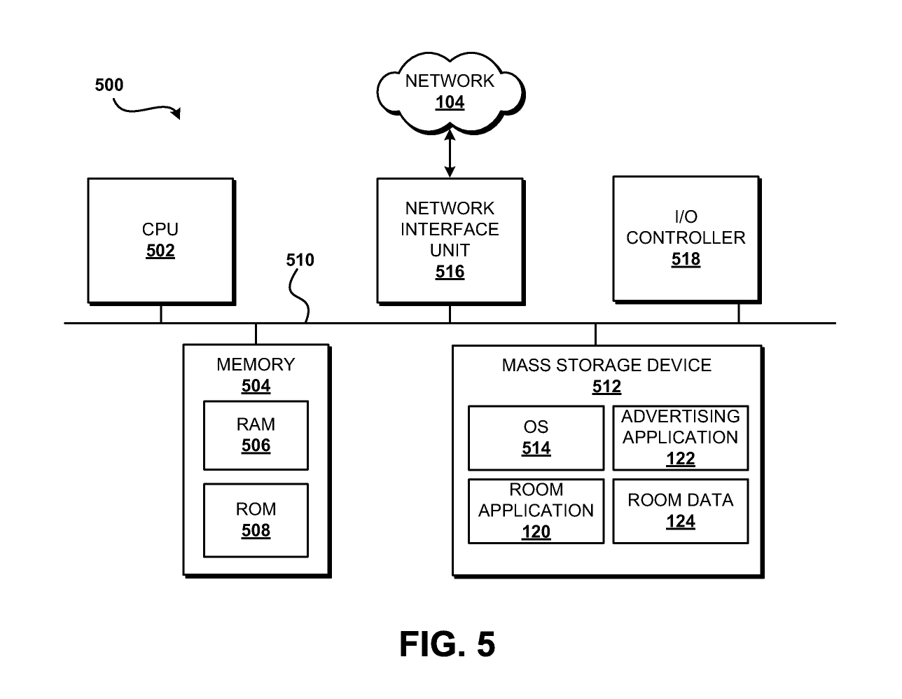

FIG. 5 illustrates an exemplary computer architecture 500 for a device capable of executing the software components described herein for providing room-based computing environments. Thus, the computer architecture 500 illustrated in FIG. 5 illustrates an architecture for a server computer, mobile phone, a PDA, a smart phone, a server computer, a desktop computer, a netbook computer, a tablet computer, and/or a laptop computer, for example the room engine 118. The computer architecture 500 may be utilized to execute any aspects of the software components presented herein.

The computer architecture 500 illustrated in FIG. 5 includes a central processing unit 502 (“CPU”), a system memory 504, including a random access memory 506 (“RAM”) and a read-only memory (“ROM”) 508, and a system bus 510 that couples the memory 504 to the CPU 502. A basic input/output system containing the basic routines that help to transfer information between elements within the computer architecture 500, such as during startup, is stored in the ROM 508. The computer architecture 500 further includes a mass storage device 512 for storing an operating system 514, the room application 120, the advertising application 122, and/or other applications (not illustrated). The mass storage device 512 also can store room data 124 and/or other data (not illustrated).

The mass storage device 512 is connected to the CPU 502 through a mass storage controller (not shown) connected to the bus 510. The mass storage device 512 and its associated computer-readable media provide non-volatile storage for the computer architecture 500. Although the description of computer-readable media contained herein refers to a mass storage device, such as a hard disk or CD-ROM drive, it should be appreciated by those skilled in the art that computer-readable media can be any available computer storage media that can be accessed by the computer architecture 500.

By way of example, and not limitation, computer-readable storage media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 500. For purposes of this specification and the claims, the phrase “computer-readable storage medium” and variations thereof, does not include communication media.

According to various embodiments, the computer architecture 500 may operate in a networked environment using logical connections to remote computers through a network such as the network 104. The computer architecture 500 may connect to the network 104 through a network interface unit 516 connected to the bus 510. It should be appreciated that the network interface unit 516 also may be utilized to connect to other types of networks and remote computer systems, for example, the client 128. The computer architecture 500 also may include an input/output controller 518 for receiving and processing input from a number of other devices, including a keyboard, mouse, or electronic stylus (not shown in FIG. 5). Similarly, the input/output controller 518 may provide output to a display screen, a printer, or other type of output device (also not shown in FIG. 5).

It should be appreciated that the software components described herein may, when loaded into the CPU 502 and executed, transform the CPU 502 and the overall computer architecture 500 from a general-purpose computing system into a special-purpose computing system customized to facilitate the functionality presented herein. The CPU 502 may be constructed from any number of transistors or other discrete circuit elements, which may individually or collectively assume any number of states. More specifically, the CPU 502 may operate as a finite-state machine, in response to executable instructions contained within the software modules disclosed herein. These computer-executable instructions may transform the CPU 502 by specifying how the CPU 502 transitions between states, thereby transforming the transistors or other discrete hardware elements constituting the CPU 502.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 500 in order to store and execute the software components presented herein. It also should be appreciated that the computer architecture 500 may include other types of computing devices, including hand-held computers, embedded computer systems, personal digital assistants, and other types of computing devices known to those skilled in the art. It is also contemplated that the computer architecture 500 may not include all of the components shown in FIG. 5, may include other components that are not explicitly shown in FIG. 5, or may utilize an architecture completely different than that shown in FIG. 5.

Based on the foregoing, it should be appreciated that technologies for providing and using room-based computing environments have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

We claim:

1. A computer-implemented method for providing a room-based computing-environment, the computer-implemented method comprising performing computer-implemented operations for:
creating a room, the room comprising a category of resources;
adding a resource to the room;
retrieving data associated with the resource;
setting permissions corresponding to the room; and
generating room data comprising data identifying the resources and data identifying the permissions corresponding to the room.

2. The method of claim 1, further comprising:
generating advertising relating to the room; and
storing data relating to the advertising with the room data corresponding to the room.

3. The method of claim 1, wherein setting the permissions comprises identifying an access control mechanism required to access the room.

4. The method of claim 1, further comprising:
creating one or more buildings, each of the buildings comprising a category of rooms; and
associating the room with one or more of the buildings based, at least partially, upon determining a category associated with the room and associating the room with a building corresponding to the determined category.

5. The method of claim 1, further comprising creating one or more items in the room, the one or more items comprising a category of resources associated with the room.

6. The method of claim 1, further comprising:
detecting access of the room-based computing environment by an entity;
determining if access to the room-based computing environment is restricted; and
in response to determining that access to the room-based computing environment is restricted, authenticating the entity.

7. The method of claim 6, further comprising determining the contents of the room-based computing environment by accessing the room data.

8. The method of claim 7, wherein the contents of the room-based computing environment are altered based, at least partially, upon whether the entity successfully authenticates.

9. The method of claim 7, wherein determining the contents of the room-based computing environment comprises generating advertising for display with the room data.

10. The method of claim 7, further comprising presenting peripheral information with the room-based computing environment.

11. The method of claim 10, wherein presenting the room-based computing environment comprises generating a user interface for navigating the room-based computing environment via a computer executing a web-based operating system, the user interface comprising
one or more user interface controls for accessing one or more buildings, each of the buildings comprising a category of rooms, and
advertising space for displaying the generated advertising.

12. The method of claim 11, further comprising in response to receiving a selection of the one or more user interface controls, presenting one or more room user interface controls for accessing the rooms, at least one of the room user interface controls comprising a door user interface control for submitting authentication information to access the resources associated with the at least one of the room user interface controls.

13. The method of claim 12, further comprising displaying a presence user interface control for accessing functionality relating to at least one of a motion detector or a camera associated with the one or more room user interface controls.

14. A computer-implemented method for providing a room-based computing environment, the computer-implemented method comprising performing computer-implemented operations for:
submitting room creation data to a room engine, the room comprising a category of resources, wherein submitting the room creation data causes the room engine to create the room;
adding a resource to the room, wherein adding the resource to the room causes the room engine to retrieve data associated with the resource; and
submitting permissions data to the room engine, the permissions data corresponding to permissions associated with the room, wherein the room engine is further configured to generate room data comprising data identifying the resources and data identifying the permissions corresponding to the room in response to receiving the permissions data.

15. The method of claim 14, wherein setting the permissions comprises identifying an access control mechanism required to access the room.

16. The method of claim 14, further comprising submitting building creation data to the room engine, wherein in response to receiving the building creation data, the room engine is configured to
create one or more buildings, each of the buildings comprising a category of rooms, and
associate the room with one or more of the buildings based, at least partially, upon determining a category associated with the room and associating the room with a building corresponding to the determined category.

17. The method of claim 14, further comprising submitting location data to the room engine, the location data comprising information identifying a geographic location associated with a client when the room creation data is submitted.

18. The method of claim 14, wherein the room engine is configured to:
detect access of the room-based computing environment by an entity;
determine if access to the room-based computing environment is restricted;
in response to determining that access to the room-based computing environment is restricted, authenticating the entity;
determine the contents of the room-based computing environment by accessing the room data, wherein the contents of the room-based computing environment are altered based, at least partially, upon whether the entity successfully authenticates, and wherein determining the contents of the room-based computing environment comprises generating advertising for display with the room data; and
presenting the room-based computing environment, wherein presenting the room-based computing environment comprises generating a user interface for navigating the room-based computing environment via a computer executing a web-based operating system, the user interface comprising
one or more user interface controls for accessing one or more of the resources, and
advertising space for displaying the generated advertising.

19. A computer-readable storage medium having computer readable instructions stored thereupon that, when executed by a computer, cause the computer to:
create one or more rooms, the one or more rooms comprising a category of resources;
create one or more buildings, the one or more buildings comprising a category of rooms;
add a room to the one or more buildings;
add a resource to the one or more rooms;
retrieve data associated with the resource, the data comprising social networking data and search data;
set permissions corresponding to the one or more buildings, wherein setting the permissions comprises identifying an access control mechanism required to access the one or more buildings;
set permissions corresponding to the one or more rooms, wherein setting the permissions comprises identifying an access control mechanism required to access the one or more rooms;
generate room data comprising data identifying the resources, data identifying the permissions corresponding to the one or more rooms, and data identifying the permissions corresponding to the one or more buildings;
generate advertising relating to the one or more rooms, the content of the advertising being based, at least partially, upon the social networking data and the search data; and
store data relating to the advertising with the room data corresponding to the one or more buildings and the one or more rooms.

20. The computer-readable storage medium of claim 19, further comprising instructions that, when executed by the computer, cause the computer to:
detect access of the room-based computing environment by an entity;
determine if access to the room-based computing environment is restricted;
in response to determining that access to the room-based computing environment is restricted, authenticate the entity;
determine contents of the room-based computing environment by accessing the room data, wherein the contents of the room-based computing environment are altered based, at least partially, upon whether the entity successfully authenticates; and
present the room-based computing environment, wherein presenting the room-based computing environment comprises generating a user interface for navigating the room-based computing environment via a computer executing a web-based operating system, the user interface comprising
one or more user interface controls for accessing the one or more buildings, wherein selection of the one or more user interface controls causes the computer to display one or more room user interface controls for accessing the one or more rooms, and
advertising space for displaying the advertising.
